(19) United States
(12) Patent Application Publication
(10) Pub. No.: US 2007/0235974 A1
(43) Pub. Date: Oct. 11, 2007

(54) Exercise and transportation device

(76) Inventor: Javier Vargas, Ontario, CA (US)

Correspondence Address: PETER GANJIAN, 3146 NORTH VERDUGO ROAD, GLENDALE, CA, 91208-1665, US

(21) Appl. No.: 11/705,304

(22) Filed: Feb. 12, 2007

Related U.S. Application Data
(60) Provisional application No. 60/789,762, filed on Apr. 6, 2006.

(51) Int. Cl. B62M 1/04

(52) U.S. Cl. 280/256

(57) ABSTRACT

The present invention discloses an exercise and transportation device such as a bicycle that includes a frame having a drive wheel rotatably supported thereupon. The bicycle includes a first and a second foot support members, which are powered by the user. A coupler assembly directs the first end of each foot support members in an arcuate path of travel, and a vertical support coupled to the front section of the frame at one end directs the second end of each foot support member in a reciprocating path of travel. A power transfer linkage is in mechanical communication with the coupler assembly and with the drive wheel. When the device is in use, a user's foot disposed upon the foot link travels in an elliptical path of travel and provides power to the foot link. This power is transferred to the drive wheel by the power transfer linkage to propel the bicycle.

### CROSS-REFERENCES TO RELATED APPLICATIONS

The present application claims the benefit of priority from related U.S. Provisional Patent Application Ser. No. 60/789,762, filed Apr. 6, 2006, the entire disclosure of which is expressly incorporated by reference.

### BACKGROUND OF THE INVENTION

(1) Field of the Invention

This invention relates to exercise and transportation devices, a non-limiting example of which is a non-stationary, upright bicycle and, more particularly, to an exercise and transportation device with an elliptical motion of pedaling.

(2) Description of Related Art

Elliptical foot motion exercise devices provide a low-impact, aerobic form of exercise in that a user's feet move along a generally elliptical path of travel that simulates a natural running and stepping motion. The elliptical action of such devices is superior to that achieved by stair steppers, stationary or non-stationary bicycles, ski machines, or the like.

Conventional, non-stationary bicycles with elliptical motion pedaling have been known for a number of years. Reference is made to the exemplary U.S. Pat. Nos. 6,485,041; 6,648,353; 6,663,127; and 6,773,022. Regrettably, most suffer from obvious disadvantages in terms of safety and efficiency. In particular, the prior art upright non-stationary bikes with elliptical motion pedaling include mechanical moving components that move closely passed the body parts of the user. An example of such a bike is disclosed in U.S. Pat. No. 6,663,127 to Miller, the entire disclosure of which is incorporated by reference. The U.S. Pat. No. 6,663,127 to Miller illustrates mechanical moving parts 18a and 18b that move passed in between the legs of the user during pedaling. This may cause serious injuries to the user if for any reason the user hands, knees, or any other body part come into contact with or bumps into the mechanically moving component while riding the bike. In general, it is never safe to have any body parts come near any mechanically moving component.

The prior art non-stationary upright bikes with elliptical motion pedaling are inefficient in terms of translating the pedaling motion into an efficient propulsion (forward motion) of the bike. In other words, the amount of energy put into pedaling by the user is not efficiently transferred to a propulsive power to move the bike forward. As an example, the U.S. Pat. No. 6,663,127 to Miller illustrates a foot link guide comprised of a pair of swing arms 8a and 18b that are coupled to a respective pair of flat foot links 14a and 14b. The pedaling of such a connection results in an inefficient transfer of energy to the wheels to move the bike forward because the vertical (up and down) range of motion of the foot links 14a and 14b is large. The higher the vertical range of motion, the less efficient the transfer of energy. For example, the highest vertical motion (the up part) is at the fore section of the reciprocating path. At this height, in order to maintain contact with the foot links 14a and 14b, the users are compelled to bend their knees to reach that height of the pedal. The greater the bent on the knees becomes, the greater the fatigue on the leg muscles when the pedal is pushed down to ride the bike forward. This is the case because the weight of the body is not used to aid in pushing the pedal, which provides an overall less efficient ride.

Heretofore available, foot powered, mobile exercise equipment has not been able to provide a suitable, elliptical path of foot travel that is safe and efficient. Accordingly, in light of the current state of the art and the drawbacks to current non-stationary bikes with elliptical motion pedaling mentioned above, a need exists for an up-right non-stationary bike with elliptical motion pedaling that would not have any moving component passing proximal the user while pedaling, and that would provide for an efficient pedaling process, which is translated into an efficient ride.

### BRIEF SUMMARY OF THE INVENTION

The present invention provides for an exercise and transportation device, comprising:
a frame having a front, middle, and back sections;
wheels coupled with the frame for support and movement of the frame along a surface;
a foot support comprised of a one piece first support member and a one piece second foot support member, with each of the first and the second foot support members having a horizontal section that is substantially parallel with ground and integral with a sloping section that is slanted upward at an angle, away from the ground;
a vertical support comprised of a first and a second vertical support members, with each of the first and the second vertical support members having a first and a second vertical end, with the first vertical ends detachably and pivotally supported upon the front section of the frame at a pivot axis, thereby enabling the first and the second vertical support members to move in a reciprocating path, away from a user;
the first and the second vertical support members being operable to engage the sloping sections, and to direct a first free ends of the sloping sections along the reciprocating path of travel;
a coupler assembly that is in mechanical communication with a second pivot axis, and is detachably in mechanical communication with a second free end of each of the horizontal sections of each of the first and the second foot support members, with the coupler assembly being operable to direct the second free ends in a substantially arcuate path of travel;
a power transfer linkage in mechanical communication with the coupler assembly, and with the wheels; whereby when the first free end of one of the sloping sections of the first and the second foot support members travels in the reciprocal path, and the second free end of that foot support travels in the arcuate path, the foot of the user supported thereupon travels in a generally elliptical path of travel, and the power transfer linkage transfers power from the coupler assembly to the wheels so as to supply propulsive power thereto.

An optional aspect of the present invention provides for an exercise and transportation device, wherein the first and the second vertical support members are pivotally supported upon a crossbar, with the crossbar coupled transverse with the front section of the frame, and having a first and a second crossbar end that coupled with each first vertical end of the first and the second vertical support members.

Another optional aspect of the present invention provides for an exercise and transportation device, wherein said coupler assembly includes a first and a second crank arm that are pivotally supported at the second pivot axis.

Yet another optional aspect of the present invention provides for an exercise and transportation device, wherein the power transfer linkage includes one of a drive chain and a belt.

Still another optional aspect of the present invention provides for an exercise and transportation device, wherein the power transfer linkage includes a transmission which is operable to selectively provide differing levels of output torque from a given power input.

A further optional aspect of the present invention provides for an exercise and transportation device, wherein each of the first and the second foot support members include a foot receiving portion, disposed between the first and the second free ends of each of the first and the second foot support members.

Yet a further optional aspect of the present invention provides for an exercise and transportation device, wherein the foot receiving portion of each of the first and the second foot support members are positioned behind the sloping sections of the first and the second foot support members.

Still a further optional aspect of the present invention provides for an exercise and transportation device, wherein when the foot of the user is disposed upon one of the first and the second foot support members, and when the first free end travels from a point at a rearward end of the reciprocating path forward along the reciprocating path, a heel portion of the foot of the user initially rises at a faster rate than a toe portion thereof, and when the first free end travels rearward along said reciprocating path of travel from a forward end thereof, the heel portion of the foot of the use initially lowers at a faster rate than the toe portion.

Another optional aspect of the present invention provides for an exercise and transportation device, wherein the frame is a bicycle frame.

Yet another optional aspect of the present invention provides for an exercise and transportation device, further including a foldable seat.

Still another optional aspect of the present invention provides for an exercise and transportation device, further including a seat with rear handlebars so that the bike can be ridden by two people.

Another aspect of the present invention provides for a device, comprising:
a frame;
wheels rotateably coupled with the frame;
a foot support comprised of a first and a second foot support members, with each of the first and the second foot support members having a horizontal section that is substantially parallel with ground and integral with a sloping section that is slanted upward at an angle, away from the ground;
a vertical support comprised of a first and a second vertical support members that are detachably coupled with a front section of the frame, with each vertical support member being operable to engage an end of the sloping sections, and to direct the ends of the sloping sections along a reciprocating path of travel;
a coupler assembly that is in mechanical communication with a pivot axis, the coupler assembly being operable to direct an end of the horizontal section in a substantially arcuate path of travel;
a power transfer linkage in mechanical communication with the coupler assembly, and with the wheels; whereby when one of the ends of the sloping section travels in the reciprocal path, and that foot support travels in the arcuate path, the foot of the user supported thereupon travels in a generally elliptical path of travel, and the power transfer linkage transfers power from the coupler assembly to the wheels so as to supply propulsive power thereto.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding parts throughout:

FIG. 1A is an exemplary first-side view illustration of one embodiment for a non-stationary upright bike with elliptical motion pedaling in accordance with the present invention;

FIG. 1B is an exemplary second-side view illustration for the non-stationary upright bike with elliptical motion pedaling illustrated in FIG. 1A;

FIG. 2 is an exemplary top view of an enlarged section for the non-stationary upright bike with elliptical motion pedaling illustrated in FIG. 1A;

FIG. 3 is an exemplary perspective view of the enlarged section illustrated in FIG. 2 in accordance with the present invention;

FIG. 4 is an exemplary side view of a portion of the drive mechanism for the non-stationary upright bike with elliptical motion pedaling illustrated in FIG. 1A;

FIG. 5 is an exemplary first-side view illustration of a second embodiment for a non-stationary upright bike with elliptical motion pedaling in accordance with the present invention;

FIG. 6A is an exemplary side view illustration of a third embodiment for a non-stationary upright bike with elliptical motion pedaling in accordance with the present invention; and

FIG. 6B is an exemplary enlarged illustration of second pivot axis for the third embodiment for the non-stationary upright bike with elliptical motion pedaling illustrated in FIG. 6A in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

Within the context of the present disclosure, it is to be understood that an “elliptical” path of foot travel comprises a generally elongated, closed, curved path of travel that encompasses mathematical ellipses, as well as more irregular shapes such as ovals, flattened ellipses and the like. In one specific elliptical path of travel, as achieved by specific embodiments of the present invention, a user's foot travels along a path such that when moving forward, the heel portion of a user's foot initially rises at a faster rate than the toe portion, and when the user's foot is moving rearward, the heel portion initially falls at a faster rate than does the toe portion. All of such elliptical paths of travel have been found to provide a comfortable and natural action that is conducive to continued and productive exercise. In addition, within the context of this disclosure, an arcuate path of travel is a closed, curved path of travel; and as such includes circular paths of travel as well as oval paths, elliptical paths, teardrop shaped paths, as well as irregular paths, which may include variously curved and straight segments. Furthermore, as is understood within the context of this disclosure, a reciprocating path of travel comprises a repetitive back and forth path, in which the forward and return paths are essentially overlapping.

As will be explained below, the present invention provides a user powered exercise device, such as a bicycle, which operates to provide an elliptical path of foot travel. The mechanical configuration of the present invention may be readily adapted to variously configured production models of bicycles; therefore, the present invention may be readily manufactured with minimal tooling commitments.

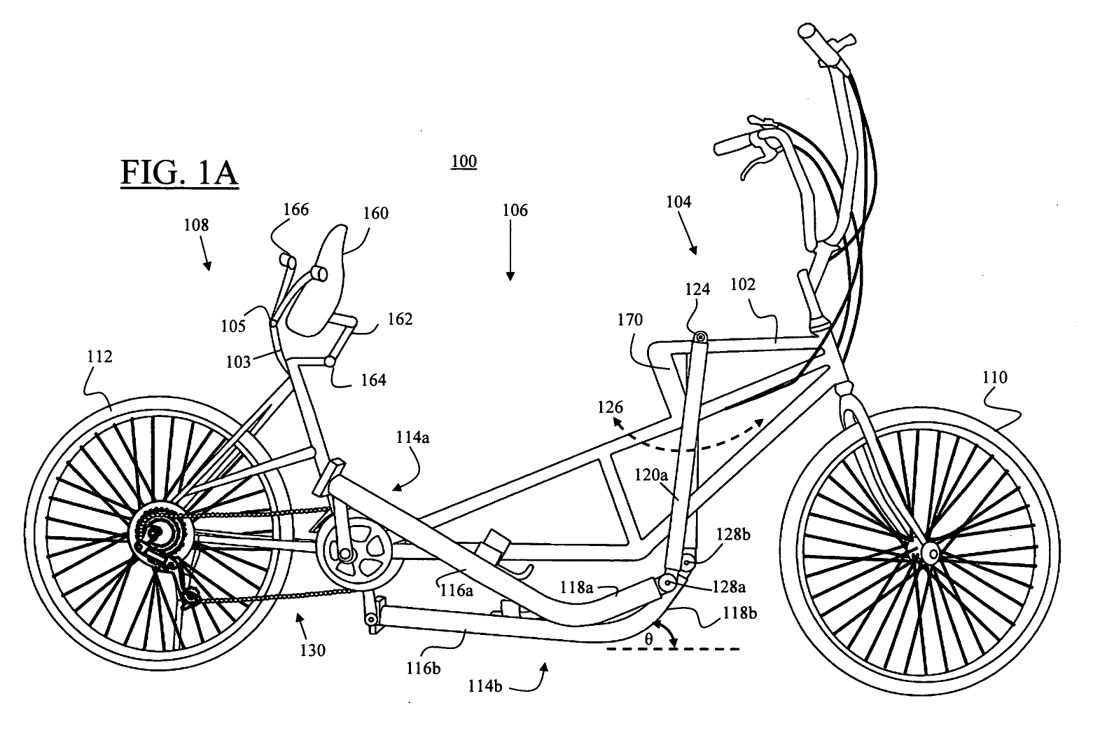

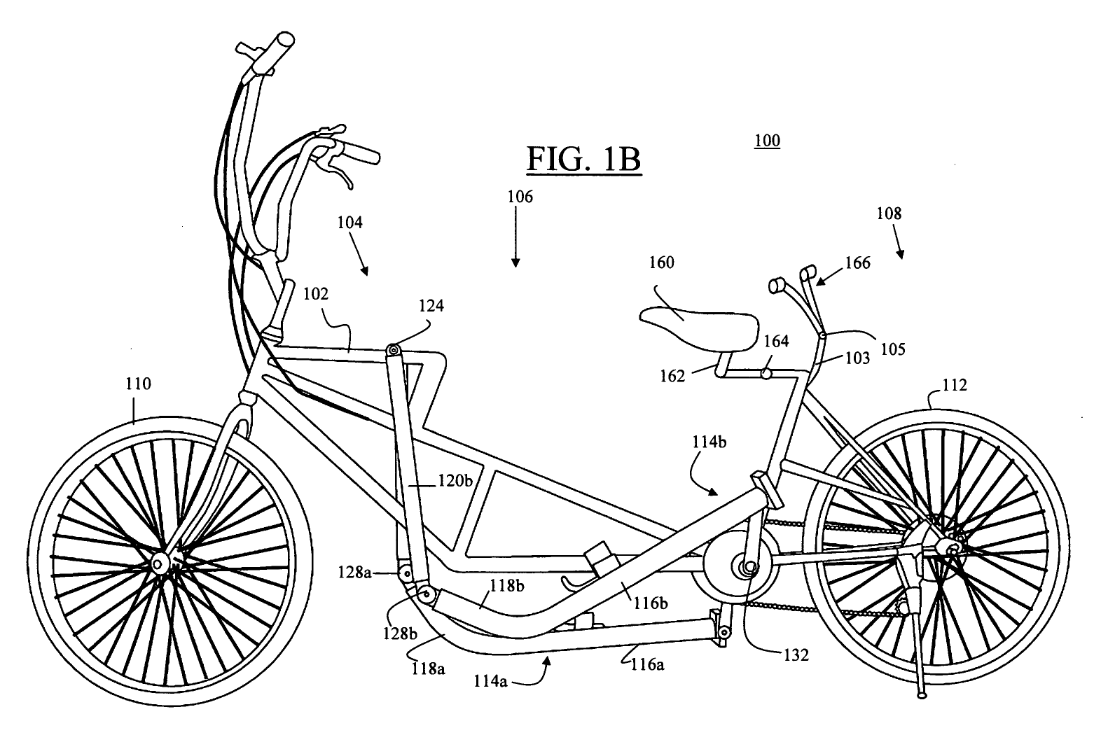

Referring to drawing FIGS. 1A to 4, the present invention provides an exercise and transportation device 100 configured as a bicycle or the like that includes a frame 102 having a front, middle, and back sections generally indicated by the respective references 104, 106, and 108, with wheels 110 and 112 coupled with the frame 102 for support and movement of the frame 102 along a surface. The device 100 further includes a foot support 114 comprised of a one-piece first foot support member 114a and a one-piece second foot support member 114b. Each of the first and the second foot support members 114a and 114b having a respective horizontal section 116a and 116b that is substantially parallel with ground and integral with a sloping section 118a and 118b that is slanted upward at an angle θ, away from the ground.

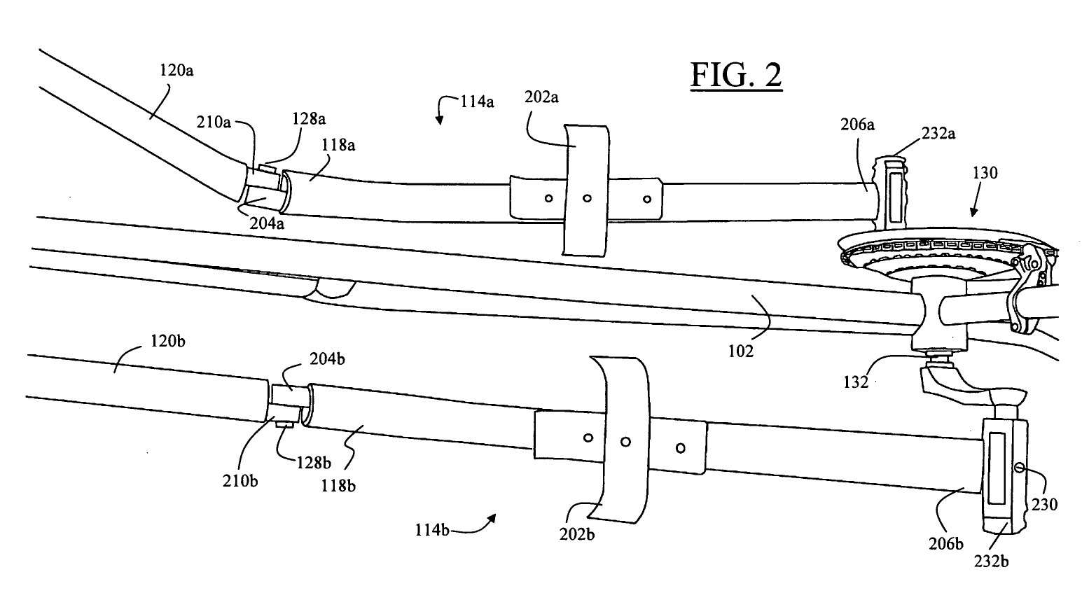

As best illustrated in FIG. 2, each of the first and the second foot support members 114a and 114b include a first free end 204a and 204b proximal the slanted sections 118a and 118b, and a second free end 206a and 206b at a distal end thereof. Further included with the first and the second foot support members 114a and 114b are a foot receiving portions 202a and 202b, disposed between the first (204a and 204b) and the second (206a and 206b) free ends. As best illustrated in FIGS. 1A and 1B, the foot receiving portions 202a and 202b are positioned behind the sloping sections 118a and 118b.

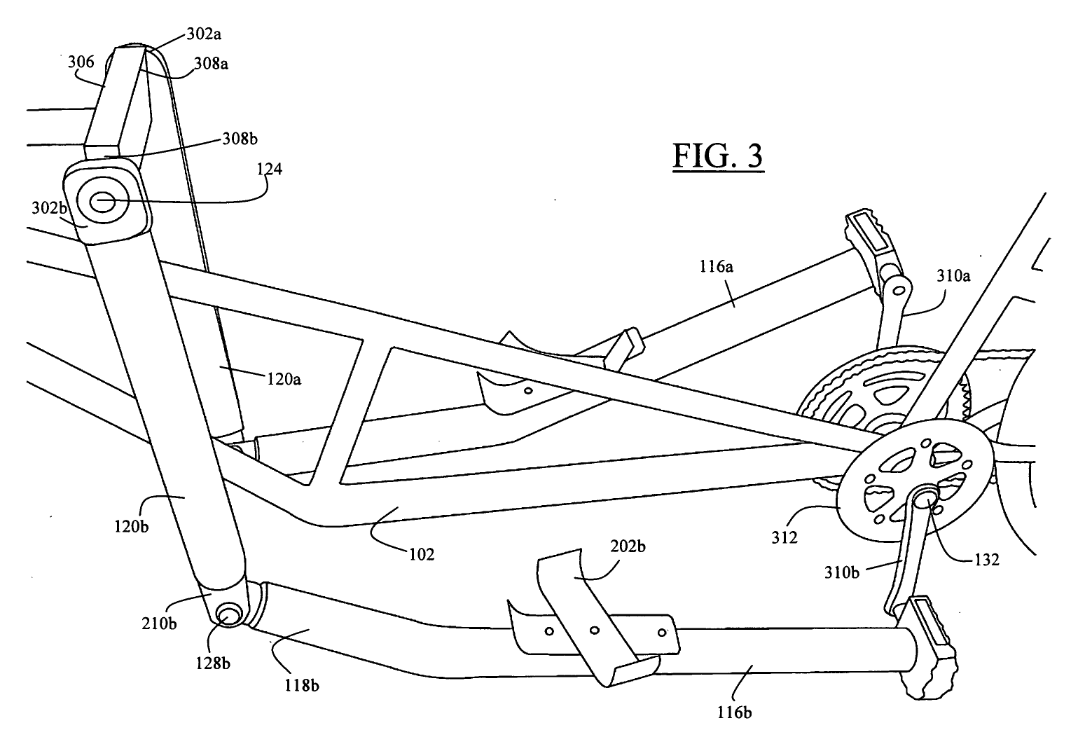

The device 100 further includes vertical supports comprised of a respective first and a second vertical support member 120a and 120b. Each of the first and the second vertical support members 120a and 120b include a first and a second vertical ends, with the first vertical ends 302a and 302b (FIG. 3) detachably and pivotally supported upon the front section 104 of the frame 102 at a first pivot axis 124. The location of the first pivot axis 124 for the vertical supports enables the first and the second vertical support members 120a and 120b to move in a reciprocating path 126, and remain away from a user during operational movement. Hence, the present invention provides an enhanced safety feature for a rider by keeping the mechanical moving components far away from user body. In general, it is never safe to have any body parts near any mechanically moving component.

In addition, the coupling of the respective first and second vertical support members 120a and 120b to the front section 104 of the bike 100 provides for a more efficient transfer of pedaling motion into propulsive motion. In other words, the amount of energy put into pedaling by the user is efficiently transferred to a propulsive power to move the bike 100 forward. With the respective first and second vertical ends 302a and 302b of the respective first and second vertical members 120a and 120b coupled with the front section 104 of the bike 100, the vertical (up and down) movement of the foot support 114 is reduced. This reduction in the vertical motion of the foot support 114 lessens fatigue of the leg muscles by reducing the bending motion of the leg at the knees, providing an overall more efficient ride, by allowing the users to also use their weight in pedaling.

The first and the second vertical support members 120a and 120b are optionally pivotally supported upon a crossbar 306, with the crossbar 306 coupled transverse with the front section 104 of the frame 102, and having a first and a second crossbar end 308a and 308b that coupled with each first vertical end 302a and 302b of the first and the second vertical support members 120a and 120b. Alternatively, as illustrated in FIGS. 1A and 1B, the vertical support members 120a and 120b may be directly coupled to a vertical bar section 170 of the frame 102, instead.

The first and the second vertical support members 120a and 120b include second vertical ends 210a and 210b being operable to engage at respective joints or second pivot axis points 128a and 128b with the respective first free ends 204a and 204b of the sloping sections 118a and 118b. The first and the second vertical support members 120a and 120b direct the first free ends 204a and 204b along a reciprocating path of travel.

With respect to measurement aspects of the foot supports in relation to the vertical supports, the shorter the foot supports, the lesser the elliptical path of travel for the foot receiving portions 202a and 202b. That is, the path of travel for the foot receiving portions would become more rounded as the foot supports are shortened. In addition, reducing the angle θ of the upwardly sloping section 118a and 118b would require a longer sized vertical supports. That is, if the foot supports are straight with no bent, the vertical supports must be extended and made longer to reach and be coupled with the foot support 114 at ends 204a and 204b. However, a longer set of vertical supports would move (or swing) further along the path 126 towards the fore or front section of the bike, and would encounter the front wheel 110. The solution would be to increase the length of the bike, which would not be practical. Therefore, the present invention provides the bent or the slanted sections 118a and 118b in order to provide shorter vertical supports, which would not contact the front wheel when moving along the reciprocating path 126 towards the front wheel. In addition, the bent or the slanted sections 118a and 118b allow for the coupling of the vertical supports with the fore section 104 of the bike 100, allowing the vertical supports to have a “rest” position normal to the ground rather than at an angle, with reduced vertical range of motion, which facilitates for a more efficient ride, as described above. However, it should be noted that increasing the slanting angle θ to make the vertical support too short would reduce the efficiency of pedaling. That is, a too short of vertical supports would increase the distance of the reciprocating path of travel 126 for the vertical supports for a single complete pedaling cycle. In general, the optimal angle θ depends on the size of the bike and the wheels.

Further included with the device 100 is a drive mechanism generally indicated by the reference 130 that is detachably in mechanical communication with a second free end 206a and 206b of each of the horizontal sections 116a and 116b of each of the first and the second foot support members 114a and 114b. The drive mechanism 130 includes a first and a second crank arm 310a and 310b that are pivotally supported at a second pivot axis 132. The drive mechanism 130 is operable to direct the second free ends 206a and 206b in a substantially arcuate path of travel.

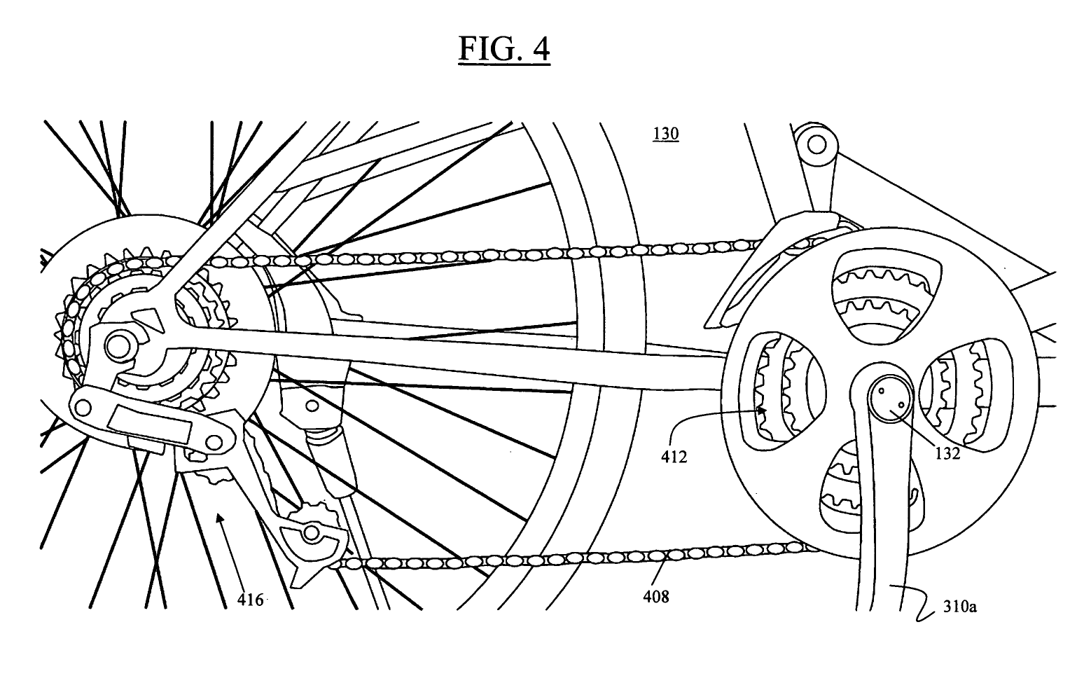

As best illustrated in FIG. 4, the drive mechanism 130 further includes a transmission gear assembly having a power transfer linkage 408 in mechanical communication with a set of front sprockets 412 and a set of rear sprockets 416. The power transfer linkage 408 includes one of a drive chain and a belt. As illustrated, the transmission gear assembly is operable to selectively provide differing levels of output torque from a given power input, similar to most conventional and well-known bicycle drive mechanisms.

During use, when the first free end (204a or 204b) of one of the respective sloping sections 118a and 118b of the first and the second foot support members 114a and 114b travels in the reciprocal path 126, and the second free end 206a or 206b of that foot support (e.g., 114a) travels in the arcuate path, the foot of the user supported thereupon the foot receiving portion travels in a generally elliptical path of travel, and the power transfer linkage 408 transfers power from a selected front sprocket 412 to the wheels so as to supply propulsive power thereto to the bike. In other words, when the foot of the user is disposed upon one of the first and the second foot support members 114a or 114b, and when the first free end 204a or 204b travels from a point at a rearward end of the reciprocating path 126 forward along the reciprocating path, a heel portion of the foot of the user initially rises at a faster rate than a toe portion thereof, and when the first free end 204a or 204b travels rearward along the reciprocating path 126 of travel from a forward end thereof, the heel portion of the foot of the use initially lowers at a faster rate than the toe portion.

As further illustrated, the present invention further provides a foldable seat 160 that folds up when not in use. The foldable seat 160 is comprised of a support member 162 coupled with the frame 102 at a seat pivot axis point 164. The seat 160 is sufficiently far to allow a rider to carry a passenger, using the seat 160 in a lowered position (FIG. 1B), with the passenger holding onto a set of rear handlebars 166 for balance. The handlebars 166 are coupled with a support 103 via a handlebar pivot axis 105, which enables the handlebars 166 to move in the same orientation as the seat 160, and be adjustably fixed to a position.

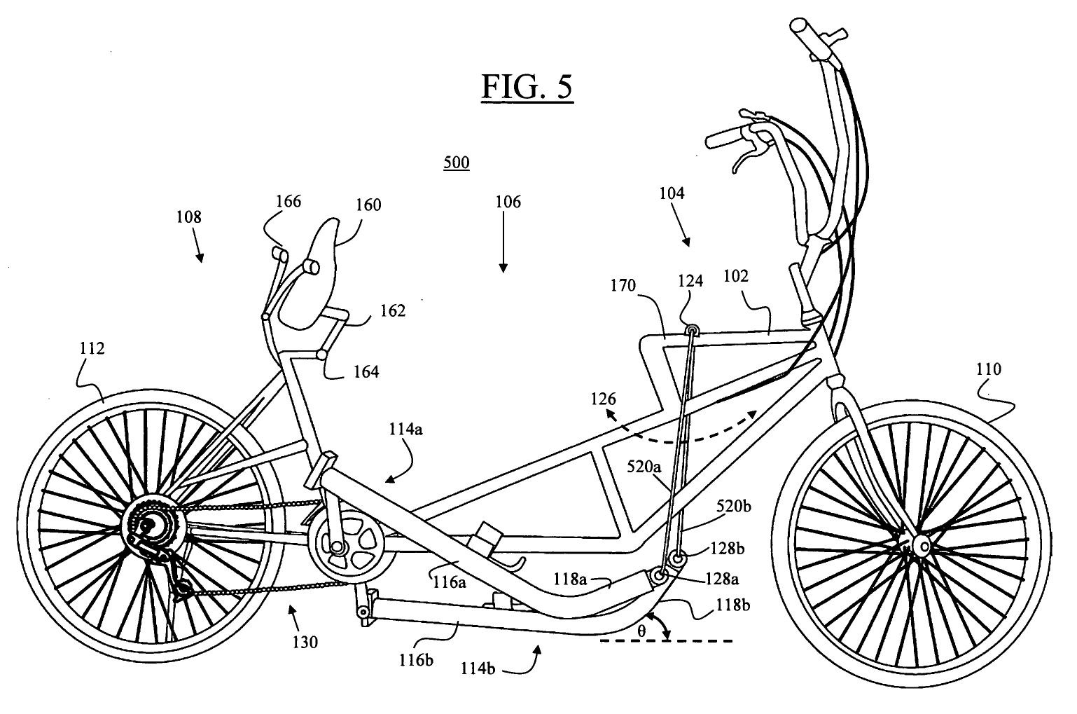

FIG. 5 is an exemplary first-side view illustration of a second embodiment for a non-stationary upright bike 500 with elliptical motion pedaling in accordance with the present invention that uses a set of wires or cables 520a and 520b for the vertical support 520. The non-stationary upright bike 500 includes similar corresponding or equivalent components as the exercise and transportation device 100 that is shown in FIGS. 1A to 4, and described above. Therefore, for the sake of brevity, clarity, convenience, and to avoid duplication, the general description of FIG. 5 will not repeat every corresponding or equivalent component that has already been described above in relation to the exercise and transportation device 100 that is shown in FIGS. 1A to 4.

As illustrated, the vertical support 520 of the exercise and transportation device 500 is comprised of a first vertical support member 520a and a second vertical support member 520b, both of which are comprised of thick intertwined wires or cable. The first ends of the respective first and second vertical support members 520a and 520b are coupled at first pivot axis 124, and the second ends thereof with the respective first and second foot support members 114a and 114b, at the respective second pivot axis points 128a and 128b. It has been found that the thick intertwined wires or cables provide a smoother ride.

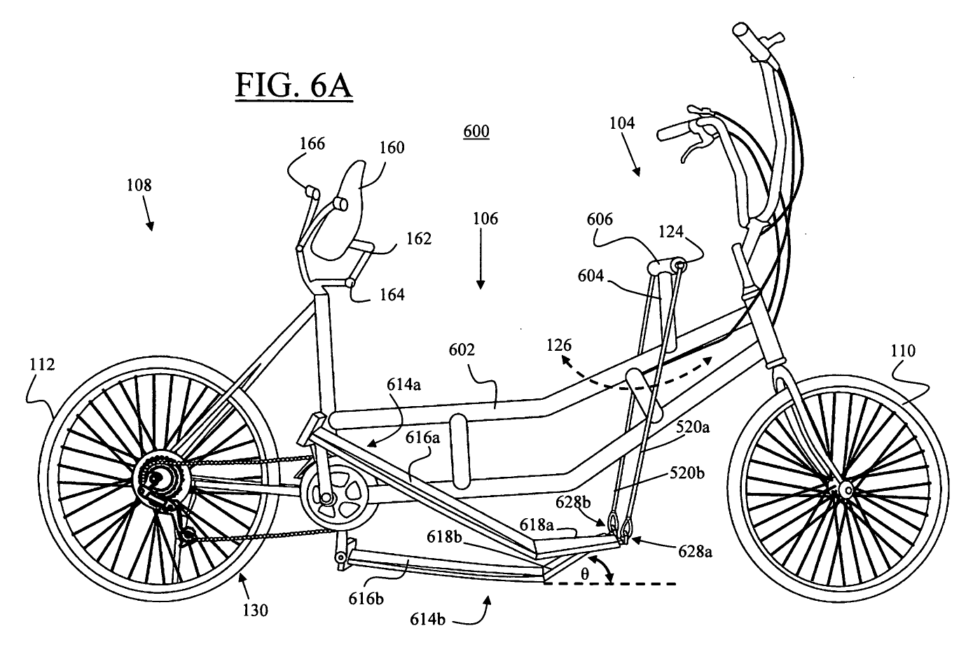

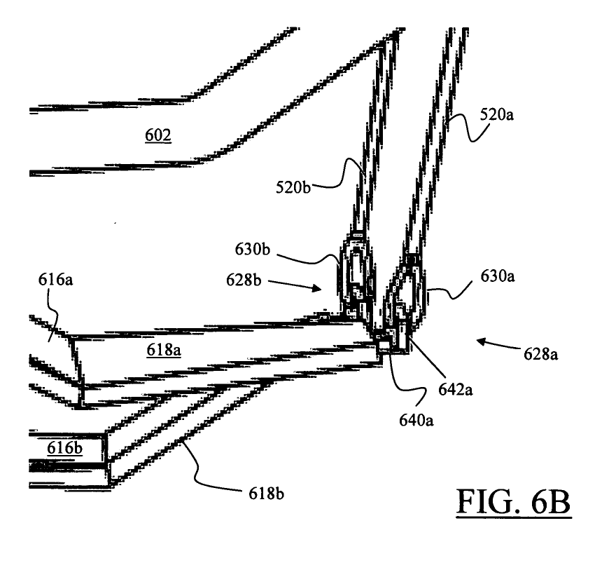

FIG. 6A is an exemplary side view illustration of a third embodiment for a non-stationary upright bike 600 (with frame 602) with elliptical motion pedaling in accordance with the present invention that uses a different set of foot support members. FIG. 6B is an enlarged illustration second pivot axis points for the third embodiment illustrated in FIG. 6A. The non-stationary upright bike 600 includes similar corresponding or equivalent components as the exercise and transportation devices 100 and 500 that is shown in FIGS. 1A to 5, and described above. Therefore, for the sake of brevity, clarity, convenience, and to avoid duplication, the general description of FIGS. 6A and 6B will not repeat every corresponding or equivalent component that has already been described above in relation to the exercise and transportation devices 100 and 500 that is shown in FIGS. 1A to 5. Although not to scale, it should be noted that the frame 602 of the bike 600 is shorter compared to other well-known tandem bikes by about 10 inches, which facilitates for a more efficient maneuvering of the bike.

As illustrated in FIGS. 6A and 6B, the vertical supports of the exercise and transportation device 600 are also comprised of a first vertical support member 520a and a second vertical support member 520b, both of which are comprised of thick intertwined wires or cable. The first ends of the respective first and second vertical support members 520a and 520b are coupled at a first pivot axis 124. The first pivot axis 124 is comprised of a “T” bar with a vertical rod 604 and a horizontal rod 606, with the horizontal rod 606 coupled transverse the vertical rod 604. The vertical rod 604 is of sufficient height to allow for an efficient ride of the bike 600, as described above in relation to the vertical support member lengths in relation to FIGS. 1 to 5.

The device 600 further includes foot supports comprised of a one-piece first foot support member 614a and a one-piece second foot support member 614b. Each of the first and the second foot support members 614a and 614b having a respective horizontal section 616a and 616b that is substantially parallel with ground and integral with a sloping section 618a and 618b that is slanted upward at an angle 0, away from the ground. The horizontal section 618a and 618b are comprised of a flat and wide continuous surface area, allowing a user foot to rest or press against any section thereof. In fact, when starting the ride, the users may commence pedaling from the back end of the horizontal section 618a and 618b, which provides for a more efficient, initial movement of the bike. As the bike begins to move, the user may move the foot forward along the flat surface area of the horizontal section 618a and 618b, which may be a more comfortable position.

As further illustrated the second ends of the first and second vertical support members 520a and 520b are coupled with the respective first and second foot support members 614a and 614b, at the respective pivot axis points 628a and 628b, the details of which is exemplarily illustrated in FIG. 6B. The pivot axis points 628a and 628b are comprised of horizontal extension sections 640a and 640b that extend at the ends of the respective sloping sections 618a and 618b, parallel along the longitudinal axis thereof, and vertical extensions 642a and 642b, which are coupled at a substantially normal angle with the respective horizontal extensions 640a and 640b. The vertical extensions 642a and 642b are comprised of an aperture that allows the connection rings 630a and 630b of the respective first and second vertical support members 520a and 520b to be coupled therewith. The connection provided by the exemplary horizontal extensions 640a and 640b and the vertical extensions 642a and 642b reduce the wear-and-tear of the ring connections 630a and 630b by allowing the vertical extensions 642a and 642b to move substantially along the same length of the reciprocating path as the rings 630a and 630b.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. For example, the vertical support and the foot support may be coupled with the bike using quick release cam levers for easily converting the bike of the present invention from an non-stationary upright bike with elliptical motion pedaling to a regular bike, when detached. Foot receiving portions may take on any form, so long as they secure the foot of the user so that the foot does not slip. The seat may comprise of a well-known fixed, non-foldable seat. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. An exercise and transportation device, comprising:
a frame having a front, middle, and back sections;
wheels coupled with the frame for support and movement of the frame along a surface;
a foot support comprised of a one piece first support member and a one piece second foot support member, with each of the first and the second foot support members having a horizontal section that is substantially parallel with ground and integral with a sloping section that is slanted upward at an angle, away from the ground;
a vertical support comprised of a first and a second vertical support members, with each of the first and the second vertical support members having a first and a second vertical end, with the first vertical ends detachably and pivotally supported upon the front section of the frame at a pivot axis, thereby enabling the first and the second vertical support members to move in a reciprocating path, away from a user;
the first and the second vertical support members being operable to engage the sloping sections, and to direct a first free ends of the sloping sections along a the reciprocating path of travel;
a coupler assembly that is in mechanical communication with a second pivot axis, and is detachably in mechanical communication with a second free end of each of the horizontal sections of each of the first and the second foot support members, with the coupler assembly being operable to direct the second free ends in a substantially arcuate path of travel;.
a power transfer linkage in mechanical communication with the coupler assembly, and with the wheels; whereby when the first free end of one of the sloping sections of the first and the second foot support members travels in the reciprocal path, and the second free end of that foot support travels in the arcuate path, the foot of the user supported thereupon travels in a generally elliptical path of travel, and the power transfer linkage transfers power from the coupler assembly to the wheels so as to supply propulsive power thereto.

2. An exercise and transportation device as set forth in claim 1, wherein the first and the second vertical support members are pivotally supported upon a crossbar, with the crossbar coupled transverse with the front section of the frame, and having a first and a second crossbar end that coupled with each first vertical end of the first and the second vertical support members.

3. An exercise and transportation device as set forth in claim 1, wherein said coupler assembly includes a first and a second crank arm that are pivotally supported at the second pivot axis.

4. An exercise and transportation device as set forth in claim 1, wherein the power transfer linkage includes one of a drive chain and a belt.

5. An exercise and transportation device as set forth in claim 1, wherein the power transfer linkage includes a transmission which is operable to selectively provide differing levels of output torque from a given power input.

6. An exercise and transportation device as set forth in claim 1, wherein each of the first and the second foot support members include a foot receiving portion, disposed between the first and the second free ends of each of the first and the second foot support members.

7. An exercise and transportation device as set forth in claim 6, wherein the foot receiving portion of each of the first and the second foot support members are positioned behind the sloping sections of the first and the second foot support members.

8. An exercise and transportation device as set forth in claim 1, wherein when the foot of the user is disposed upon one of the first and the second foot support members, and when the first free end travels from a point at a rearward end of the reciprocating path forward along the reciprocating path, a heel portion of the foot of the user initially rises at a faster rate than a toe portion thereof, and when the first free end travels rearward along said reciprocating path of travel from a forward end thereof, the heel portion of the foot of the use initially lowers at a faster rate than the toe portion.

9. An exercise and transportation device as set forth in claim 1, wherein the frame is a bicycle frame.

10. An exercise and transportation device as set forth in claim 1, further including a foldable seat.

11. An exercise and transportation device as set forth in claim 1, further including a seat with rear handlebars.

12. A device, comprising:
a frame;
wheels rotateably coupled with the frame;
a foot support comprised of a first and a second foot support members, with each of the first and the second foot support members having a horizontal section that is substantially parallel with ground and integral with a sloping section that is slanted upward at an angle, away from the ground;
a vertical support comprised of a first and a second vertical support members that are detachably coupled with a front section of the frame, with each vertical support member being operable to engage an end of the sloping sections, and to direct the ends of the sloping sections along a reciprocating path of travel;
a coupler assembly that is in mechanical communication with a pivot axis, the coupler assembly being operable to direct an end of the horizontal section in a substantially arcuate path of travel;
a power transfer linkage in mechanical communication with the coupler assembly, and with the wheels; whereby when one of the ends of the sloping section travels in the reciprocal path, and that foot support travels in the arcuate path, the foot of the user supported thereupon travels in a generally elliptical path of travel, and the power transfer linkage transfers power from the coupler assembly to the wheels so as to supply propulsive power thereto.

13. A device as set forth in claim 12, wherein the first and the second vertical support members are pivotally supported upon a crossbar, with the crossbar coupled transverse with the front section of the frame, and having a first and a second crossbar end that coupled with each first vertical end of the first and the second vertical support members.

14. A device as set forth in claim 12, wherein said coupler assembly includes a first and a second crank arm that are pivotally supported at the pivot axis.

15. A device as set forth in claim 12, wherein the power transfer linkage includes one of a drive chain and a belt.

16. A device as set forth in claim 12, wherein the power transfer linkage includes a transmission which is operable to selectively provide differing levels of output torque from a given power input.

17. A device as set forth in claim 12, wherein each of the first and the second foot support members include a foot receiving portion, disposed between a first and a second free ends of each of the first and the second foot support members.

18. A device as set forth in claim 17, wherein the foot receiving portion of each of the first and the second foot support members are positioned behind the sloping sections of the first and the second foot support members.

19. A device as set forth in claim 12, wherein when the foot of the user is disposed upon one of the first and the second foot support members, and when a first free end travels from a point at a rearward end of the reciprocating path forward along the reciprocating path a heel portion of the foot of the user initially rises at a faster rate than a toe portion thereof, and when the first free end travels rearward along said reciprocating path of travel from a forward end thereof, the heel portion of the foot of the use initially lowers at a faster rate than the toe portion.

20. A device as set forth in claim 12, wherein the frame is a bicycle frame.

21. An exercise and transportation device as set forth in claim 12, further including a foldable seat.

22. An exercise and transportation device as set forth in claim 12, further including a seat with rear handlebars.
